(19) United States
(12) Patent Application Publication
(10) Pub. No.: US 2023/0121590 A1
(43) Pub. Date: Apr. 20, 2023

(54) METHOD AND DEVICE FOR COOLING OR HEATING BIO-PHARMACEUTICAL FLUIDS

(71) Applicant: Single Use Support GmbH, Kufstein (AT)

(72) Inventor: Roland JENEWEIN, Kramsach (AT)

(21) Appl. No.: 17/968,191

(22) Filed: Oct. 18, 2022

(30) Foreign Application Priority Data
Oct. 19, 2021 (EP) 21203453.2

(51) Int. Cl. B01L 7/00; A61J 1/16

(52) U.S. Cl. CPC B01L 7/00; A61J 1/165

(57) ABSTRACT

A cooling or heating device for cooling and/or heating fluids includes a housing and a plurality of cooling plates. The cooling plates are arranged inside the housing, and the cooling plates each comprise at least one cooling channel for guiding a cooling or heating medium through the cooling plates. A container support surface is provided for arranging at least one first container containing a fluid to be heated or cooled inside the housing, and there is a first air blower in the housing for blowing air onto the cooling plates and/or into spaces between the cooling plates.

### BACKGROUND OF THE INVENTION

The present invention is concerned with a cooling or heating device for cooling and/or heating fluids, and a method for cooling and/or heating fluids.

Cooling or heating devices according to the prior art comprise a housing and a plurality of cooling plates. The cooling plates are arranged inside the housing, and the cooling plates each comprise at least one cooling channel for guiding a cooling or heating medium through the cooling plates.

Such a cooling or heating device for cooling fluids, in particular liquids, which are contained in containers, are for example described in unpublished European Patent Application no. 20181117.1 (incorporated by reference herein in its entirety) and its foreign counterparts. Such cooling or heating devices are adapted to cool or heat fluids which occur in or result from a bio-pharmaceutical production process, to which it may be referred to as bio-pharmaceutical fluids in the following.

Bio-pharmaceutical fluids are commonly stored in Single Use Bags (bags which are made by bonding two plastic sheets around the periphery) of varying volumes, which Single Use Bags are themselves put in rigid containers, as known for example from WO 2018129576 A1. These containers are generally of a relatively flat configuration so that they can be conveniently brought between the cooling plates, such as disclosed in unpublished European Patent Application no. 20181117.1. The cooling and/or heating of the containers together with the fluids therein is therefore particularly easy and effective.

As a side note, bio-pharmaceutical fluids in general represent a very large value as the production of these fluids is complex and difficult. Therefore, freezing of bio-pharmaceutical liquids is desired in order to protect the bio-pharmaceutical fluids from chemical degradation, impacts, and other detrimental outside influences. In the frozen state, the bio-pharmaceutical liquids can be stored and transported, while the frozen liquids are resilient and protected. Where or when the bio-pharmaceutical liquid is needed, it can then be thawed and used.

It is also common to store bio-pharmaceutical fluids also in bottles of varying sizes. Using the sort of cooling or heating device as described in unpublished European Patent Application no. 20181117.1 also for bottles is obviously not as easy or effective as for containers with Single Use Bags.

Known in the prior art are, in principle, other types of cooling devices where a gaseous cooling medium of low temperature is prepared outside of the housing and where the low temperature cooling medium is then conducted into the housing (so called blast freezers in the context of bio-pharmaceutical fluids). These types of freezers obviously are less well suited for cooling fluids which are stored in containers with Single Use Bags as they lack the direct heat transfer between the containers and the cooling plates making the cooling less effective.

### SUMMARY OF THE INVENTION

The object of the invention is to provide a cooling or heating device and a method for cooling and/or heating with which the cooling and or heating of fluids, in particular bio-pharmaceutical fluids, contained in bottles is improved regarding ease of use and/or effectiveness of the heating or cooling. Preferably, the object of the invention is more specifically to provide a cooling or heating device and a method for cooling and/or heating with which (bio-pharmaceutical) fluids which are stored in containers with Single Use Bags and/or which are stored in bottles can both be cooled and/or heated effectively and easily.

Regarding the cooling or heating device, this object is achieved wherein:
there is provided a container support surface for arranging at least one first container containing a fluid to be heated or cooled inside the housing, and
in the housing there is provided at least one first air blower for blowing air onto the cooling plates and/or into spaces between the cooling plates.

Regarding the method, the object is achieved by:
arranging at least one first container containing a fluid to be heated or cooled inside a housing on a container support surface,
blowing air onto the cooling plates and/or into spaces between the cooling plates using at least one first air blower arranged in the housing, and
cooling or heating the air inside the housing by guiding a cooling or heating medium through at least one cooling channel disposed inside cooling plates which are arranged inside the housing.

According to the invention, the air which is blown onto the cooling plates and/or into spaces between the cooling plates is cooled or heated by heat transfer to or from the cooling plates. In turn, the at least one first container on the container support surface and the fluid contained in the at least one first container is cooled or heated by the cooled or heated air.

In some embodiments of the invention, it is even possible to cool or heat fluids contained in the at least one first container (e.g. bottles) arranged on the container support surface and contained in at least one second container (e.g. containers with Single Use Bags) disposed adjacent to or between the cooling plates at the same time.

According to the invention, it is also possible to only cool or heat fluid contained in the at least one second container, i.e. without the at least one first container being present. The invention can therefore provide a hybrid cooling or heating device which can be used for cooling or heating containers with Single Use Bags or bottles and the fluid contained therein.

According to the invention, it is therefore possible to effectively and easily cool, in particular freeze, and/or heat, in particular thaw, fluids independently of whether the fluids are contained in the at least one first container (e.g. bottles) arranged on the container support surface or contained in at least one second container (e.g. containers with Single Use Bags) disposed adjacent to or between the cooling plates. Therefore, a “hybrid freezer” can for example be realised according to the invention.

Compared to blast freezers, it has been observed that the invention allows fluids in first containers such as bottles to be frozen and thawed in a particularly quick and homogeneous manner, which is obviously advantageous particularly in the context of bio-pharmaceutical fluids.

According to the invention, more than one first container and/or more than one second container containing the fluid to be cooled or heated can be cooled or heated according to the invention in one instance.

In preferred embodiments, the cooling or heating device can be adapted for cooling and heating fluids depending on the situation. Of course, the invention can also be realized in devices and methods where only cooling or only heating is envisaged.

In particularly preferred embodiments, the fluid that is cooled or heated is a liquid with (small) gas component or no gas component. It is of course also possible to cool or heat goods with a solid component according to the invention.

In particularly preferred embodiments the invention is used for cooling or heating bio-pharmaceutical fluids. The at least one first air blower can preferably be arranged inside the housing in its entirety.

In preferred embodiments, the at least one first air blower (and/or the at least one second air blower, see below) can be a rotating fan with fan blades propelling air onto the cooling plates or the spaces there between. In larger housings it may be advantageous to use more than one first air blower.

Motors for driving the rotating motion of the fan blades can be present in preferred embodiments.

The housing can be adapted for minimizing heat transfer across the housing (with certain obvious potential exceptions like power supply and/or control connections for the at least one first or second air blower leading through a wall of the housing, as well as pipes for supplying and/or discharging cooling medium to or from the cooling plates), using for example an insulating material.

The cooling plates can be of substantially plate-like base shape, for example, with a rectangular base shape. Other geometrical features can of course be present, such as fastenings for mounting the cooling plates in the housing and/or connectors for connecting the at least one cooling channel with an apparatus for providing cooling or heating medium.

That the cooling plates are called “cooling plates” herein should not be construed as limiting in the sense that these plates can only be used for cooling. According to the invention, the fluid can also be heated using the cooling plates by guiding a heating medium of higher temperature than the fluid to be heated through the at least one cooling channel. Analogously, this is of course also true for the cooling channels.

In some embodiments, the container support surface can simply by an inner bottom surface of the housing on which the at least one first container can be put. In other embodiments, a separate surface for supporting the at least one first container in the housing can be provided inside the housing.

The container support surface can be a single contiguous surface or can be separated into separate sub-surfaces. Formulated differently, there can be a single container support surface or there can be two or more separate support surfaces.

Multiple container support surfaces can also be arranged above each other, in order to realize multiple layers of container support surfaces such that at least one first container can be arranged above each other on the container support surfaces.

As mentioned before, the at least one first container can be a bottle holding the fluid and/or the at least one second container can be a (preferably rigid) container with a Single Use Bag (bags which are made by bonding two plastic sheets around the periphery) holding the fluid disposed therein. In general, the at least one first container can be a container for fluid with a substantially upright configuration, and the at least one second container can be a container for fluid with a substantially flat configuration.

It is of course possible to cool or heat a single type of fluid according to the invention or to cool or heat different types of fluids (in different first or second containers) in one instance of cooling or heating.

Protected is also a use of a cooling or heating device according to the invention for cooling, in particular freezing, and/or heating, in particular thawing, a fluid which occurs in or results from a bio-pharmaceutical production process. As is clear from the introductory part, the invention offers particularly preferred advantages for such use cases.

The cooling plates can have side lengths between 500 mm and 1500 mm, preferably between 700 mm and 1200 mm, and particularly preferably between 800 mm and 1100 mm.

The at least one first air blower can be configured to blow the air along an imaginary first air blower axis, the first air blower being arranged such that the first air blower axis leads through the cooling plates or through the spaces between the cooling plates. In such embodiments the air gets blown directly (i.e. without flow obstruction and/or sufficiently close) onto the cooling plates and/or into spaces between the cooling plates such that it is cooled or heated quickly and efficiently.

The cooling plates (preferably all of the cooling plates) can be arranged inside the housing parallel to each other and/or the cooling plates (preferably all of the cooling plates) can be arranged inside the housing in a substantially horizontal configuration.

Here, a horizontal configuration can be understood as the cooling plates being arranged such that a plane of the cooling plates projected onto which they have the largest area is substantially horizontal.

In preferred embodiments, the cooling plates can be mounted movably in the housing, wherein the cooling plates are movable relative to each other between first relative positions and second relative positions, wherein first distances present between neighbouring cooling plates in the first relative positions are large enough to admit at least one second container containing the fluid or a further fluid to be cooled or heated, and second distances present between neighbouring cooling plates in the second relative positions are smaller than in the first relative positions, but preferably not zero.

Mounting the cooling plates in this way inside the housing can make it particularly easy for a person or device to place the at least one second container in the spaces between the cooling plates (first relative positions). At the same time the cooling plates can be arranged closer to the at least one second container (particularly preferably such that the cooling plates are in contact with the at least one second container) when the fluid in the at least one second container is to be heated or cooled (second relative positions). The latter affords better heat transfer between the at least one second container and the cooling plates.

In preferred embodiments, there can be a non-zero distance between the cooling plates in the second relative positions even when there is no at least one second container in a space between two specific cooling plates. This allows air blown into the housing by the at least one first blower to enter these spaces between the cooling plates so that the air in theses spaces gets cooled or heated quickly and efficiently. This is particularly preferred in embodiments where the first air blower axis leads through the cooling plates or through spaces between the cooling plates. However, embodiments where two cooling plates between which no at least one second container is present contact each other are of course conceivable.

The second distances can be between 5 mm and 100 mm, preferably between 10 mm and 50 mm, and particularly preferably between 24 mm and 30 mm.

In particularly preferred embodiments, the cooling or heating device according to the invention can be used such that the at least one first container (e.g. bottles) and the at least one second container (e.g. containers with Single Use Bags) are present in the housing and get cooled or heated according to the invention at the same time. In these embodiments, it can be advantageous to not fill all spaces between the cooling plates with second containers in order to allow the air blown into the housing by the at least one first blower to enter the non-occupied spaces between the cooling plates for quick and efficient cooling or heating of the air as described before.

A drivetrain (preferably together with a motor drive) can be provided for moving the cooling plates from the first relative positions to the second relative positions.

As mentioned, the content of unpublished European Patent Application no. 20181117.1 is incorporated by reference herein in its entirety. Specifically with respect to the movable mounting (first relative positions, second relative positions) and the drive train it is referred to European Patent Application no. 20181117.1 regarding example embodiments.

In preferred embodiments, the cooling plates can be arranged above the container support surface, resulting in a particularly compact overall arrangement. Embodiments where the container support surface is above the cooling plates or next to the cooling plates are of course conceivable in principle.

In such embodiments, it can be preferable that there is a minimum distance between the cooling plates, in particular in the first relative positions and/or the second relative positions, and the container support surface such that the at least one first container can be placed onto the container support surface without touching the cooling plates.

Such a minimum distance can also make it quite easy to place the at least one first container on the container support surface.

The minimum distance can, for example, be between 500 mm and 1000 mm, preferably between 600 mm and 800 mm, and particularly preferably approximately 700 mm.

In particularly preferred embodiments, at least one second air blower can be provided inside the housing configured to blow the air along an imaginary second air blower axis. The second air blower axis preferably intersects a further space above the container support surface, preferably intersects the further space between the container support surface and the cooling plates, such that the at least one second air blower blows, preferably cooled, air directly onto the at least one first container.

In this way, the at least one second air blower can be used to create an advantageous air flow within the housing. For example, the at least one first air blower can blow the air directly onto the cooling plates and/or into the spaces between the cooling plates and/or onto the at least one second container (if present), then the at least one second air blower can blow the cooled air directly onto the at least one first container, and afterwards the air flow can re-join the air flow onto the cooling plates created by the at least one first blower.

Particularly in embodiments where the cooling plates are arranged above the container support surface, side walls of the housing can serve as deflection surfaces such that air propelled by the at least one first air blower can be deflected into an area of the at least one second air blower after passing the cooling plates, and/or air propelled by the at least one second air blower can be deflected into an area of the at least one first air blower inside the housing after passing the at least one first container. This results in a rolling air flow within the housing, which yields a particularly effective cycle of cooling or heating the air and cooling or heating the fluid in the at least one first container and/or the at least one second container.

An apparatus for providing cooling and/or heating medium preferably comprises at least one of:
a pump for pumping cooling or medium through the at least one cooling channel of each of the cooling plates,
a medium cooler for cooling the cooling or heating medium,
a medium heater for heating the cooling or heating medium, and/or
pipes for establishing fluid communication between the apparatus and the at least one cooling channel of the cooling plates.

The apparatus for providing cooling and/or heating medium can be arranged in a separate housing or can be arranged in the housing in which the cooling plates and the container support surface are also arranged.

The pipes can preferably be embodied as flexible tubes so as to accommodate relative motion between the cooling plates and the housing.

Silicone oil can in preferred embodiments be used as cooling or heating medium.

In preferred embodiments, a control unit is configured to control the at least one first air blower and the apparatus for providing cooling and/or heating medium such that the at least one first air blower and the apparatus for providing cooling and/or heating are active at the same time.

The control unit can also control the motor drive for driving the drive train for the relative motion of the cooling plates.

The control unit can be configured to move the cooling plates into the at least one first relative position before or after cooling or heating for when the at least one first container and/or the at least one second container is placed in the cooling or heating device or removed therefrom. However, the cooling plates can also be moved into the at least one second position for placing the at least one first container on the container support surface before or after cooling or heating, which can make it particularly easy to place the at least one first container on the container support surface, as there may be a bigger clearance between the container support surface and the cooling plates.

Users of the cooling or heating device according to the invention can also choose (e.g. via a input or switching element) between the at least one second relative positions and the at least one first relative positions before or after cooling or heating, possibly consecutively so that the user can first place or remove the at least one first container and then the at least one second container, or vice versa.

Before the cooling or heating the control unit can then actuate the motor drive in order to move the cooling plates into the second relative positions.

The housing can comprise a flap for opening and closing the housing for placing or removing the at least one first container and/or the at least one second container in or from the cooling or heating device, respectively.

### BRIEF DESCRIPTION OF THE DRAWINGS

Further advantages and details of the invention are apparent from the figures and the accompanying description of the figures. The figures show:

FIGS. 1 to 10 an embodiment of the cooling or heating device according to the invention in different use cases,

FIG. 11 a schematic sketch of an embodiment according to the invention, and

FIG. 12 a schematic sketch of a cooling plate.

### DETAILED DESCRIPTION OF THE INVENTION

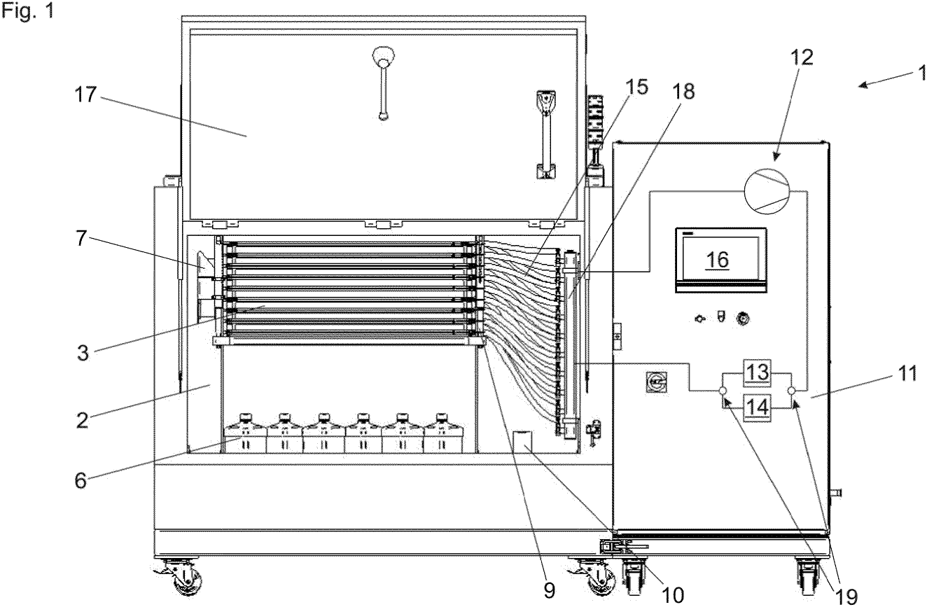

FIG. 1 shows an embodiment of a cooling or heating device 1 according to the invention in a front view. The cooling or heating device 1 comprises a housing 2, cooling plates 3, a first air blower 7, and a second air blower 10.

In this example there are nine cooling plates 3 with dimensions of approximately 1074 mm by 850 mm.

In the depiction of FIG. 1 a flap 17 of the housing 2 is in an open configuration. In this configuration the inside of the housing 2 is visible and users of the cooling or heating device 1 can access the inside, e.g. in order to place or remove containers in or from the housing 2, respectively.

The cooling plates 3 are arranged in a parallel horizontal configuration. Each of the cooling plates 3 is connected to an apparatus 11 for providing a cooling or heating medium to the cooling plates 3, in particular a cooling channel 4 in each of the cooling plates 3, by way of pipes 15.

The apparatus 11 for providing cooling or heating medium in this embodiment comprises a pump 12, a medium cooler 13, a medium heater, and a distributor 18 for distributing and collecting the cooling or heating medium from and back into a single circuit in the apparatus 11 for providing cooling or heating medium.

Furthermore, there are switching valves 19 present which can be used to pump the cooling or heating medium either through the medium cooler 13 or the medium heater 14.

A control unit 16 is connected to and controls the following: The pump, the medium cooler 13, the medium heater 14, the first air blower 7, and the second air blower 10.

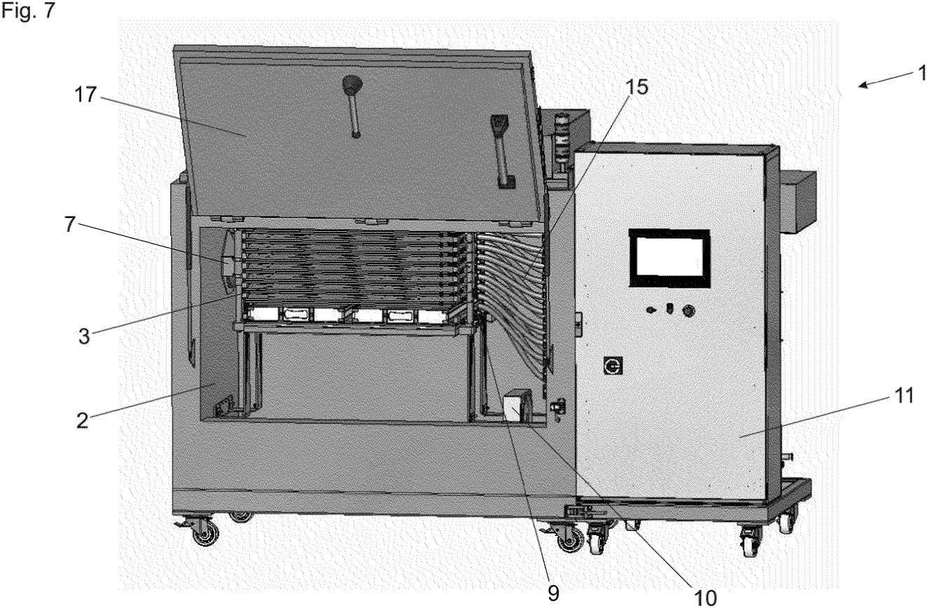

In the configuration shown in FIG. 1 first containers 6 in the form of bottles are arranged inside the housing 2. The first containers 6 are arranged on a container support surface 5 (see FIG. 7).

After closing the flap 17 a user can start a cooling or heating process using the control unit 16, e.g. by issuing a starting command by the push of a button.

The control unit 16 then activates the pump 12, sets the switching valves 19 to the desired operation setting (such that the cooling or heating medium either flows through the medium cooler 13 or the medium heater 14), and activates the first air blower 7 as well as the second air blower 10.

If the fluid in the at least one first containers 6 is to be cooled, in particular frozen, the cooling or heating medium is pumped through the medium cooler 13 and is then distributed to the cooling channels 4 of the cooling plates 3. By heat transfer from the air inside the housing 2 to the cooling plates 3 and into the cooling or heating medium the air in the vicinity of the cooling plates 3 is cooled.

The first air blower 7 blows air onto the cooling plates 3 where the air is cooled (or alternatively heated as desired) as described before. There are small distances between the cooling plates 3 such that the air can pass through the spaces between the cooling plates 3 for particularly effective cooling of the air.

The first air blower 7 is mounted inside the housing 2, and in this embodiment is disposed entirely inside the housing 2.

In this embodiment the first air blower 7 is mounted to a side of a drivetrain 9 for driving a movement of the cooling plates 3 (see below).

The distances between the cooling plates 3 in this configuration (second distances) are between 24 mm and 30 mm.

The housing 2 subsequently leads the cooled air down to the area of the second air blower 10, which blows the cooled air directly onto the second containers 6. By heat transfer from the fluid in the first containers 6 to the cooled air blown onto the first containers 6 by the second air blower the fluid contained in the first containers 6 is cooled and/or frozen.

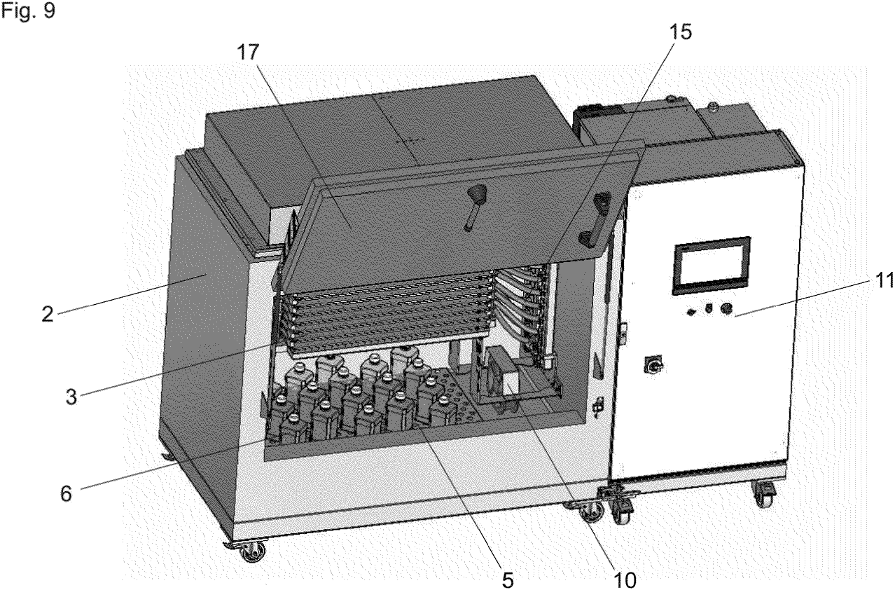

The air is then deflected by the housing 2 back to the area of the first air blower 7 where it can re-join the air flow onto the cooling plates 3. Regarding the resulting rolling air flow inside the housing 2 it is also referred to FIG. 9.

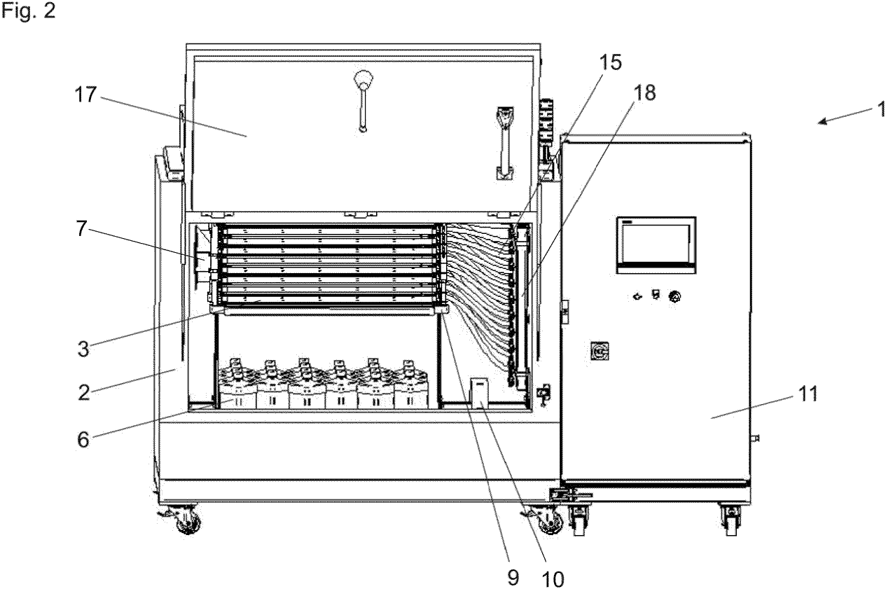

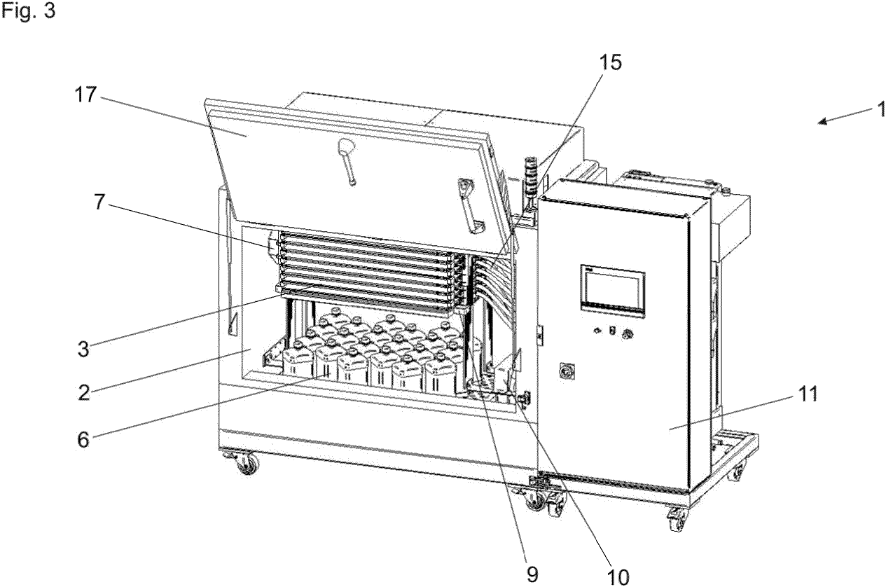

FIGS. 2 and 3 show the embodiment of FIG. 1 in perspective views.

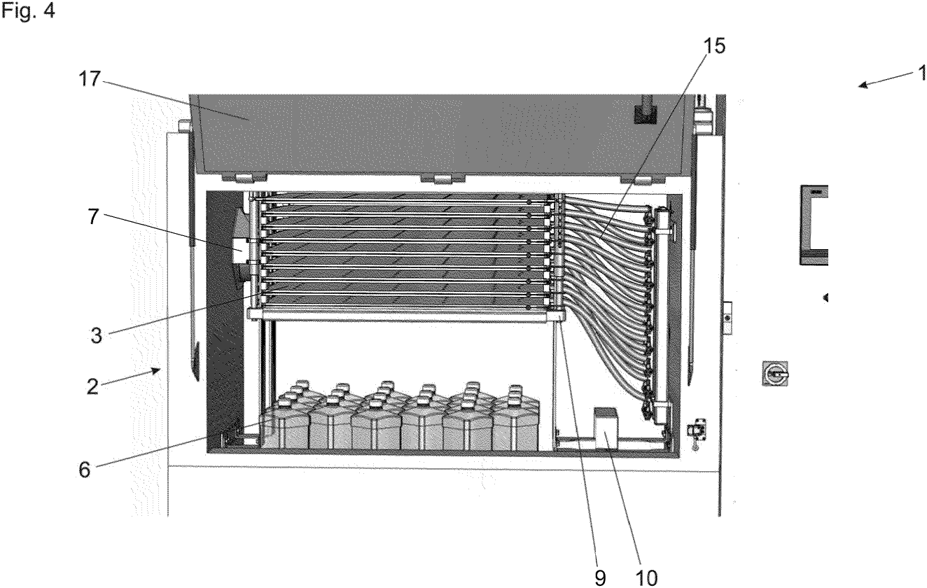

FIG. 4 shows the inside of the housing of the embodiment of the FIG. 1 in an enlarged view.

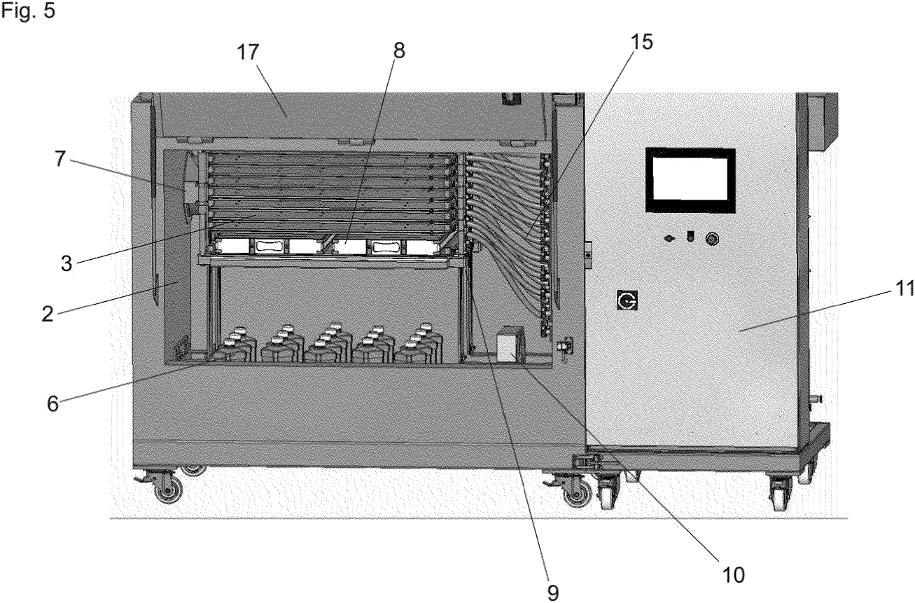

FIG. 5 shows the embodiment of FIG. 1 where there are also second containers 8 present. These are arranged between two of the cooling plates 3. The second containers 8 can be loaded between the cooling plates 3 by vertically moving the cooling plates 3 down from the configuration in FIGS. 1 and 2.

As is described and shown in unpublished European Patent Application No. 20181117.1 the cooling plates 3 can be moved collectively in a downward direction so that there are bigger relative distances between the cooling plates 3 compared to the configuration as depicted in FIG. 1. For performing the movement of the cooling plates 3 there is provided a drive train 9 and a motor drive (not shown).

The bigger distances between the cooling plates 3 permit introduction of the second containers 8 into the resulting slots between the cooling plates 3.

The cooling plates 3 can then be moved up again so that the second containers 8 contact the adjacent cooling plates 3 while the rest of the cooling plates are in the relative positions shown in FIG. 1.

In this way the cooling plates 3 directly cool or heat the fluid contained in Single Use Bags in the second containers 8, while at the same time the first containers 6 are cooled or heated as described in connection with FIG. 1.

Accordingly, the cooling or heating device 1 according to the invention can effectively and easily be used to cool or heat fluid contained in bottles and containers of a substantially flat configuration as shown in FIG. 5.

The configurations and embodiments are in particular well suited for cooling, in particular freezing, or heating, in particular thawing, bio-chemical fluids, as both fluids contained in the first containers 6 (bottles) and in the second containers 8 (containers with Single Use Bags) can be cooled or heated easily and effectively.

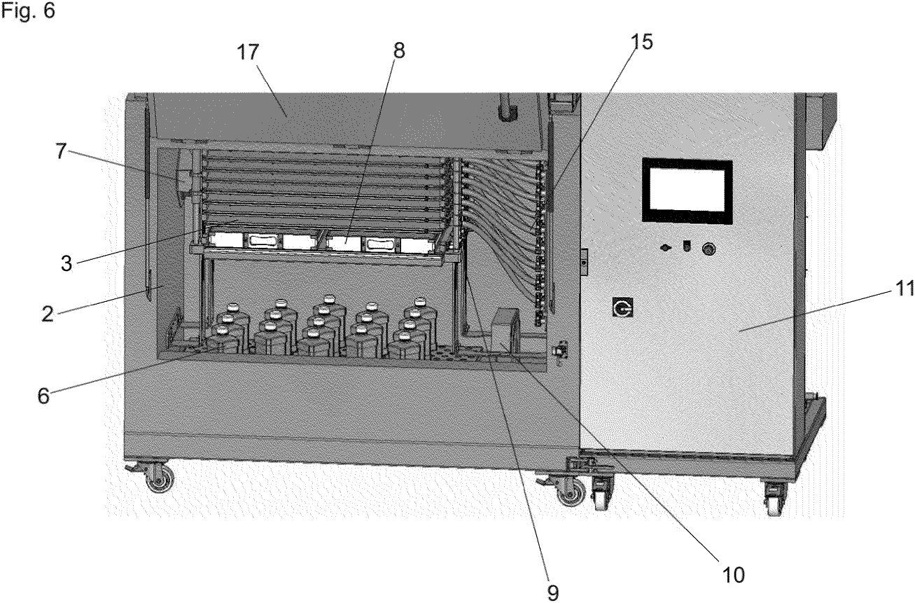

FIG. 6 shows the configuration of FIG. 5 from a slightly different perspective.

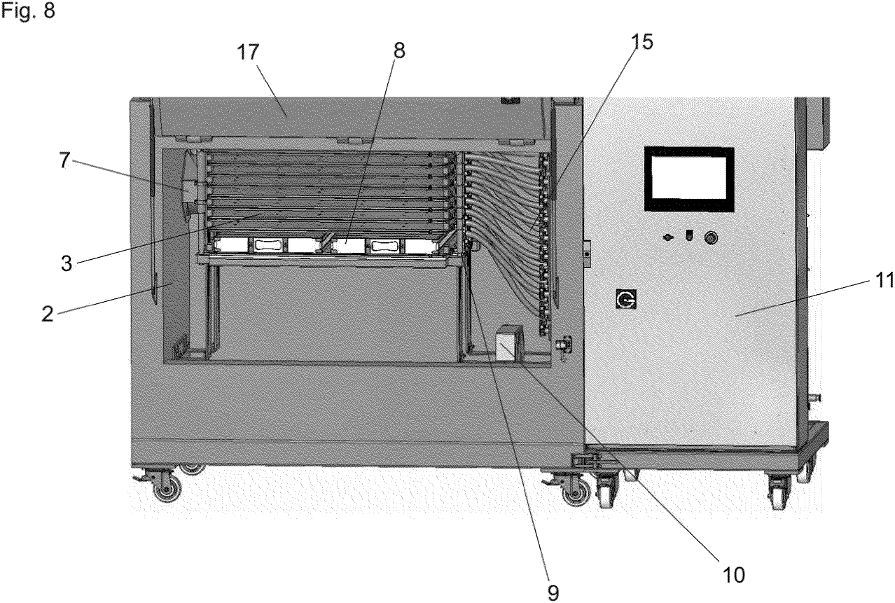

FIGS. 7 and 8 show that the cooling or heating device 1 can also be used to only cool or heat fluid in second containers 8.

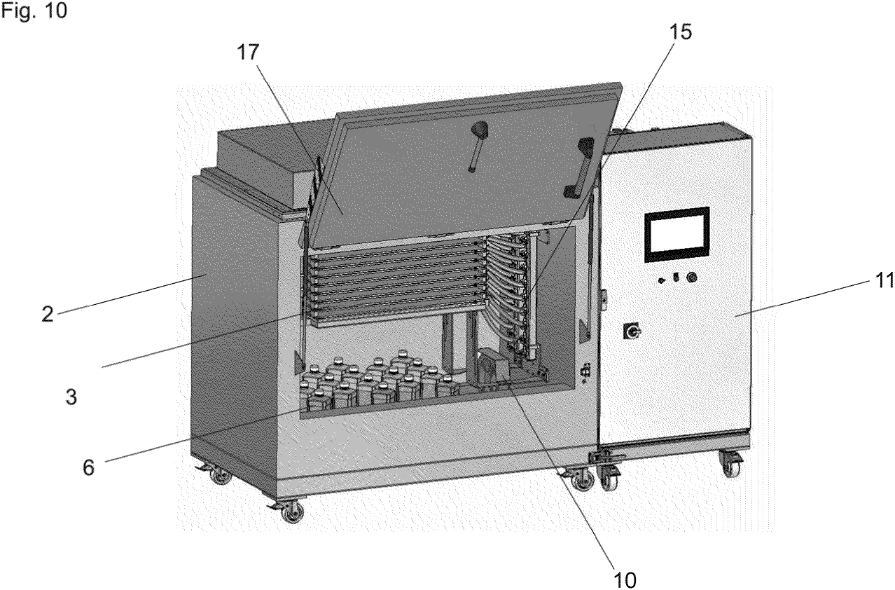

FIGS. 9 and 10 show the embodiment of FIG. 1 from yet different perspectives.

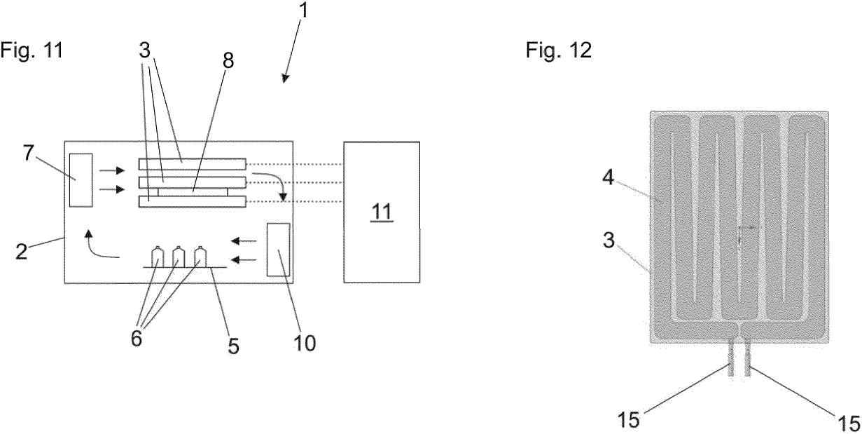

FIG. 11 is a schematic sketch of an embodiment of the invention. The arrows visualise the rolling flow pattern of the air within the housing 2.In particular, the first air blower 7 blows the air onto the cooling plates 3 (only three are shown as an example), into the spaces between the cooling plates 3, and onto second containers 8 which may be present between the cooling plates 3.

The cooled or heated air gets then deflected by the housing 2 into the vicinity of the second air blower 10. The second air blower 10 blows the cooled or heated air onto the first containers 6. Finally, the housing 2 deflects the air to re-join the air flow in the area of the first air blower 7.

FIG. 12 shows a schematic sketch of a cooling plate 3 as it can be used in embodiments of the invention in a sectional view. The pipes 15 supply cooling or heating medium to the cooling channel 4 disposed within the cooling plate 3. After the cooling or heating medium has passed through the cooling channel 4 the pipes 15 lead the cooling or heating medium back to the apparatus 11.

1. A cooling or heating device for cooling and/or heating fluids comprising:
a housing;
a plurality of cooling plates, the cooling plates being arranged inside the housing, and the cooling plates each comprising at least one cooling channel for guiding a cooling or heating medium through the cooling plates;
a container support surface for arranging at least one first container containing a fluid to be heated or cooled inside the housing; and
at least one first air blower in the housing for blowing air onto the cooling plates and/or into spaces between the cooling plates.

2. The cooling or heating device according to claim 1, wherein the at least one first air blower is configured to blow the air along an imaginary first air blower axis, the first air blower being arranged in the housing such that the first air blower axis leads through the cooling plates or through the spaces between the cooling plates.

3. The cooling or heating device according to claim 1, wherein the cooling plates are arranged inside the housing parallel to each other and/or the cooling plates are arranged inside the housing in a substantially horizontal configuration.

4. The cooling or heating device according to claim 1, wherein the cooling plates are mounted movably in the housing, wherein the cooling plates are movable relative to each other between first relative positions and second relative positions, wherein first distances present between neighbouring cooling plates in the first relative positions are large enough to admit at least one second container containing the fluid or a further fluid to be cooled or heated, and second distances present between neighbouring cooling plates in the second relative positions are smaller than in the first relative positions, but preferably not zero.

5. The cooling or heating device according to claim 4, wherein there is provided a drivetrain for moving the cooling plates from the first relative positions to the second relative positions.

6. The cooling or heating device according to claim 1, wherein the cooling plates are arranged above the container support surface.

7. The cooling or heating device according to claim 1, wherein there is provided at least one second air blower inside the housing configured to blow the air along an imaginary second air blower axis, wherein the second air blower axis intersects a further space above the container support surface, preferably intersects the further space between the container support surface and the cooling plates.

8. The cooling or heating device according to claim 1, wherein there is provided an apparatus for providing cooling and/or heating medium, the apparatus preferably comprising at least one of:
a pump for pumping cooling or medium through the at least one cooling channel of each of the cooling plates,
a medium cooler for cooling the cooling or heating medium,
a medium heater for heating the cooling or heating medium, and/or
pipes for establishing fluid communication between the apparatus and the at least one cooling channel the cooling plates.

9. The cooling or heating device according to claim 8, further comprising a control unit configured to control the at least one first air blower and the apparatus for providing cooling and/or heating medium such that the at least one first air blower and the apparatus for providing cooling and/or heating are active at the same time.

10. The cooling or heating device according to claim 1, wherein the housing comprises a flap for opening and closing the housing.

11. The use of a cooling or heating device according to claim 1 for cooling, in particular freezing, and/or heating, in particular thawing, a fluid which occurs in or results from a bio-pharmaceutical production process.

12. A method for cooling and/or heating fluids, in particular using the cooling or heating device according to claim 1, comprising:
arranging at least one first container containing a fluid to be heated or cooled inside a housing on a container support surface,
blowing air onto the cooling plates and/or into spaces between the cooling plates using at least one first air blower arranged in the housing, and
cooling or heating the air inside the housing by guiding a cooling or heating medium through at least one cooling channel disposed inside cooling plates which are arranged inside the housing.
